(19) United States
(12) Patent Application Publication
(10) Pub. No.: US 2003/0163451 A1
(43) Pub. Date: Aug. 28, 2003

(54) System and method for guaranteeing exactly-once updates to a data store

(76) Inventors: Yair Amir, Bethesda, MD (US); Michal Miskin-Amir, Bethesda, MD (US)

Correspondence Address: GOODWIN PROCTER L.L.P, 7 BECKER FARM RD, ROSELAND, NJ, 07068, US

(21) Appl. No.: 10/353,124

(22) Filed: Jan. 28, 2003

Related U.S. Application Data
(60) Provisional application No. 60/352,378, filed on Jan. 28, 2002.

(51) Int. Cl. G06F 7/00; G06F 17/30

(52) U.S. Cl. 707/1; 707/3

(57) ABSTRACT

A system and method for guaranteeing exactly-once updates to data stores. The present invention includes a table in the data store to store indicia of actions that have been taken thereby facilitating recovery and allowing software to determine if an action has already been applied or needs to be resent for application.

### CROSS-REFERENCE TO RELATED APPLICATIONS

This Application claims the benefit of U.S. Provisional Application No. 60/352,378 filed Jan. 28, 2002 and which is hereby incorporated by reference in its entirety.

### STATEMENT REGARDING FEDERALLY SPONSORED RESEARCH OR DEVELOPMENT

Not relevant.

### SEQUENCE LISTING, TABLES OR COMPUTER PROGRAM LISTING APPENDIX

None.

### BACKGROUND OF THE INVENTION

1. Field of the Invention

This invention generally relates to a system and method for guaranteeing exactly-once updates to data stores.

2. Description of the Related Art

Information is becoming increasingly important in today's economic, political and social environment. To manage this information, data store systems are used to store, manage and exploit this information. Generally, a data store system is comprised of a data store and software (which is a separate entity from the data store) that access and applies actions (for example, SQL commands) to the data store. A data store system may take many different forms. For instance, in many applications, a large number of clients may routinely query and update the same data store. In this type of environment, the location of the data store can have a significant impact on application response time and availability. This type of centralized approach manages only one copy of the data store, is simple and contradicting views between replicas are not possible. This centralized approach, however, suffers from two major drawbacks. First, there are performance problems due to high server load or high communication latency for remote clients. Second, there are problems of relating to the availability of the central data store which are caused by server downtime or lack of connectivity. Clients that are in areas of the network that are temporarily disconnected from the server thus cannot be serviced.

In another architecture, the server load and downtime problems can be addressed by replicating the data store to form a cluster of peer servers that coordinate updates. However, communication latency and server connectivity remain a problem when clients are scattered across a wide-area network and the cluster is limited to a single location. Wide-area data store replication coupled with a mechanism to direct clients to the best available server can greatly enhance both the response time and availability. Nevertheless, these systems continue to exhibit problems with providing a consistent view across all servers.

In all cases, a fundamental challenge in data store replication is ensuring global data store consistency. One way to replicate a data store is to use software that is external to the data store to manage the replication process. To ensure consistency between all the replicas of the data store, it is important to make sure that all actions are applied exactly once and in the same order at all the replicas of the data store. However, a fault may occur in the data store, in the software, or in the communication between them. Upon recovery of the system, the software does not know what pending actions have been received and applied at the data store. If the software sent an action and cannot determine whether the action was actually applied or lost because of the fault, the software may resend the action to the data store, and in this case the action may be applied to the data store twice. On the other hand, if the software does not resend the action to the data store, this actions may be lost and never applied. The software cannot safely continue applying actions to the data store while preserving exactly-once semantics.

Accordingly, there is a need for systems and methods that guarantees exactly-once semantics, i.e. that the effects of each action are reflected exactly once, especially in those systems where the software and data store are separate and not integrated into a single database management system.

### BRIEF SUMMARY OF THE INVENTION

The present invention uses the Atomicity, Consistency and Durability properties of a data store to differentiate between the actions that are already reflected in the data store and the actions that are not. In the preferred embodiment the software and data store are separate entities.

To effectuate the advantages of this invention, in the preferred embodiment a table is included in the data store to store indicia of actions that have been taken. In the preferred embodiment, the indicia is provided by the software and is not the internal database indexes which may be used internally by the data store. Preferably the indicia is unique for each action, to the extent that the software permits it. For example, using a 2-byte integer for and indicia provides 65,536 unique numbers that can be used and assigned to actions.

In the event that a recovery is needed, software queries the data store for the set of action indicia. Relying on the atomicity property provided by the data store, actions represented by these indicia are guaranteed to be completely reflected in the data store while pending actions that are not represented by these indicia are guaranteed to be completely not reflected in the data store. To complete the recovery, the software then applies all ordered actions with indicia not included in the set according to their (not necessarily sequential) order. This guarantees the required exactly-once semantics.

### BRIEF DESCRIPTION OF THE DRAWINGS

The figures below depict various aspects and features of the present invention in accordance with the teachings herein.

FIG. 1 is a high-level overview of an exemplary embodiment of a system in accordance with one aspect of the invention.

FIG. 2 is a block diagram showing in greater detail a data store modified to practice one aspect of the invention.

FIGS. 3-9 illustrate the operation of the present invention in guaranteeing exactly-once updates.

### DETAILED DESCRIPTION OF THE INVENTION

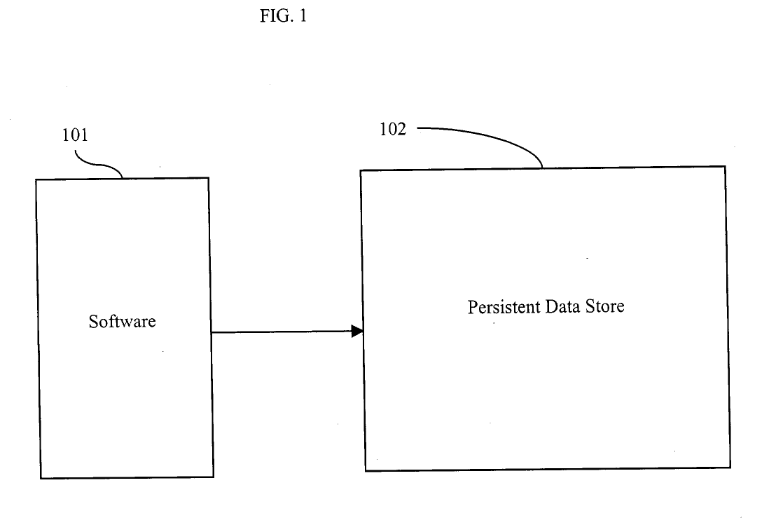

FIG. 1 shows a typical data store system which is generally comprised of two basic components: a persistent data store 102, and software 101 that gets a global persistent (but not necessarily total) order of actions that updates the data store 102. In some cases, the software and data store may be combined into a single application or file. For example, in MS Access an application written using MS Access functions is stored with the database as one application. In this case, the MS Access application is still separate from the database because the software application is not part of the data store (i.e., the database) itself, and can not know what actions were updated. In other example, a separate application may be written in a high-level language like C++ and this application sends SQL statements to an Oracle database through a programming API. Software 101 applies the actions to data store 102 according to that order. The software and the data store are separate entities that communicate via communication mechanisms that are well known to one skilled in the art.

Data store 102 provides at least the following basic services: (i) a Data Access service which allows the addition of new data records, changes to data and retrieval of data, and (ii) a Data Management services which allows multiple clients to work on data store 102 simultaneously (concurrency), allowing multiple records to be changed (transactions), and surviving application, system and network crashes (recovery).

Transactions permit clients to make multiple changes appear at once. Data store 102 provides the following transaction properties: (i) Atomicity which is that the changes happen all at once or not at all, (ii) Consistency which is where data store 102 is in a consistent (correct) state when the transaction begins and when it ends and (iii) Durability which is if the system or application crashes after a transaction completes, the effects of that transaction are not lost.

In the preferred embodiment, software 101 has a global persistent order of actions. Each action may be comprised of multiple operations that execute as one transaction. The global persistent order assigns an indicia, such as an ordinal, to each action. The global persistent order may be a sequential order or some other order (e.g. one that can be represented by a direct acyclic graph) that defines the order by which actions have to be applied to data store 102.

The present invention exploits the Atomicity, Consistency and Durability properties of data store 102 to differentiate between actions that are already reflected in data store 102 and actions that are not. Use of the Atomicity property of data store 102 ensures that after a recovery there is no action for which only some (but not all) of its effects are reflected in data store 102.

In a data store that is modified to practice the present invention, a new set of fields, preferably in a new table, will be added to data store 102. This set of fields will store the indicia of the actions reflected in data store 102, as assigned by the global persistent order. Each action that updates data store 102 will be transformed into a transaction that includes the original action and an additional update that inserts the indicia of the action that was determined by the global persistent order, to the new set of fields. Software 101 will apply this transaction to the data store instead of the original action.

If the system crashes, upon recovery, software 101 queries data store 102 for the values stored in the new set of fields. Relying on the atomicity property provided by data store 102, actions represented by these values are guaranteed to be completely reflected in the data store while pending actions that are not represented by these values are guaranteed to be completely not reflected in the data store. To complete the recovery, software 101 then applies all ordered actions with indicia not included in the set of fields according to their (not necessarily sequential) order. This process guarantees the required exactly-once semantics.

An optimization can be made regarding values representing actions that are known to be applied and reflected in the data store. Such values can be deleted from the new set if the system can ensure they will not be re-applied after a recovery.

Another optimization can be made if the global persistent order is sequential. In this case, only one new field needs to be added to data store 102. This field stores the indicia of the last ordered action reflected in data store 102, as assigned by the global persistent order. Each action (that updates data store 102) will be transformed in the modified system into a transaction that includes the original action and an additional update that sets the new field to the indicia of the action that was determined by the global persistent order. Software 101 will apply this transaction to data store 102 instead of the original action.

In an embodiment using this optimizations, upon recovery, software 101 queries data store 102 for the value of the new field. For instance, say that the value of the new field is x. Relying on the atomicity property provided by data store 102, knowing the value is x means that all the effects of all the actions up to and including the action with indicia x are reflected in the data store, while none of the effects of any action with indicia (assuming illustrative purpose an ordered numbering system) higher than x is reflected in the data store. To complete the recovery, the software then sequentially applies all ordered actions with indicia higher than x to the data store. This process guarantees the required exactly-once semantics.

### 1. EXAMPLE 1

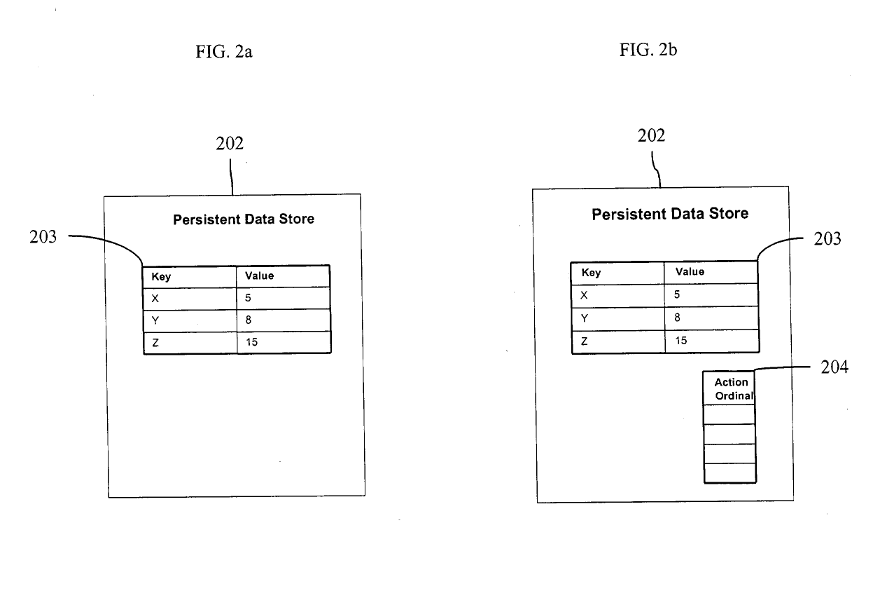

To better illustrate the present invention, the following figures depict an example of one embodiment for practicing the present invention, although the invention disclosed herein is not limited to this example and can be extended by one skilled in the art. In particular, FIG. 2a show an exemplary persistent data store 202 which holds a table 203 of records having key, value pairs. The key represents a unique identifier for each record and the value represents the data associated with a particular record having a particular key. Table 203 shows three exemplary records, of course, many other records and types of data stored are used in “real-life” data stores. In accordance with one aspect of the present invention, to guarantee the application of exactly-once semantics, FIG. 2b shows data store 202 having an additional Action Ordinal Table 204 added. Action Ordinal Table 204 stores the ordinals of the actions reflected in the data store, as assigned by the global persistent order software.

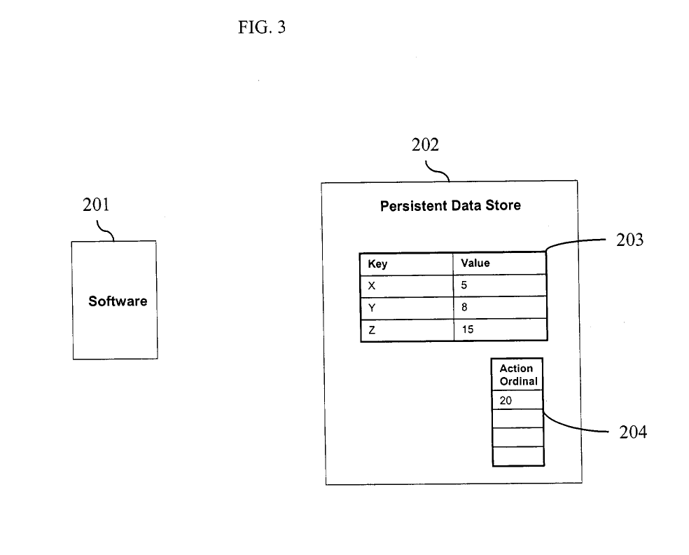

Assume that an action (having indicia which are ordinals) has an ordinal of “20” has been applied to table 203. FIG. 3 shows that the only ordinal of an action that was already applied by the data store is “20”, and this is reflected in Action Ordinal Table 204. Next assume for purposes of this example that software 201 now sends a new action to the data store.

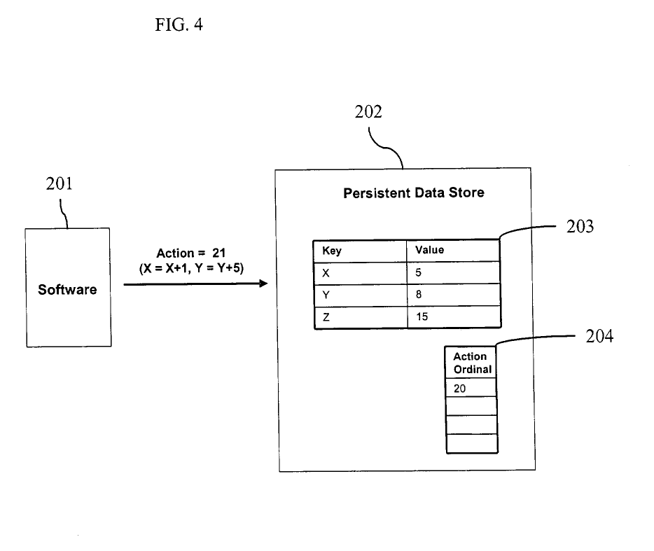

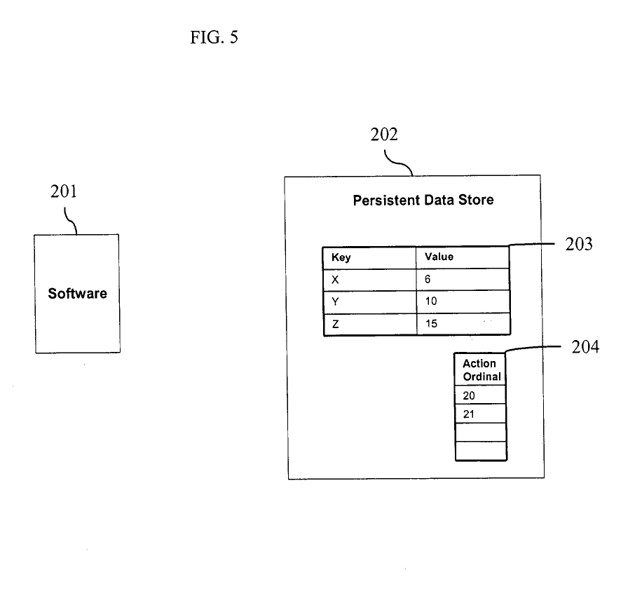

FIG. 4 depicts this showing that software 201 sends an action with an associated ordinal of “21“ to data store 202. The indicia “21” in this example is associated with the action to increment the value in the record with key=“X” (“record X”) and to add “5” to the value of the record with key=“Y” (“record Y”) (“action ‘21’”). Note that although the action numbers are sequential in this example, the method taught by the present invention is not limited to sequential numbers. The action itself is sent to data store 202 together with the request to add indicia “21” to Action Ordinal Table 204, as one single transaction. Because of the atomicity property of data store 202, the present invention guarantees that if table 203 is updated with the new values, Action Ordinal Table 204 will be updated as well. FIG. 5 shows the state of data store 202 after the application of the action associated with “21”. In particular, record X now has a value of “6” and record Y has a value of “10”. Action Ordinal Table 204 has been update to include “21”, indicating that action “21” has been performed. Software 201 also retains a log of actions in the order to be applied and their associated indicia.

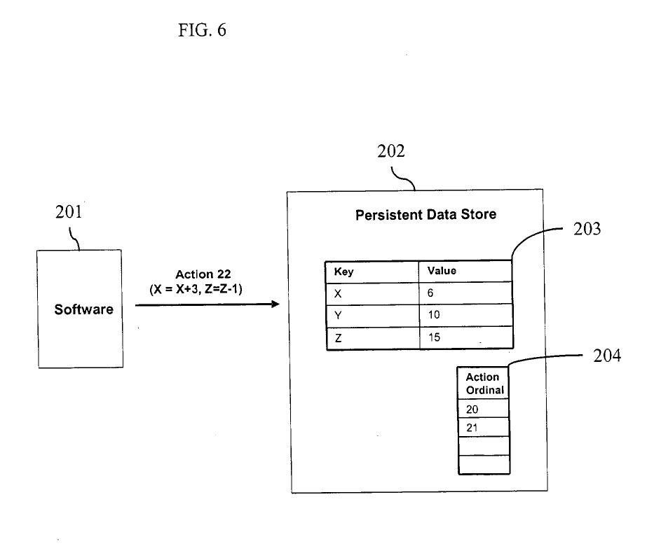

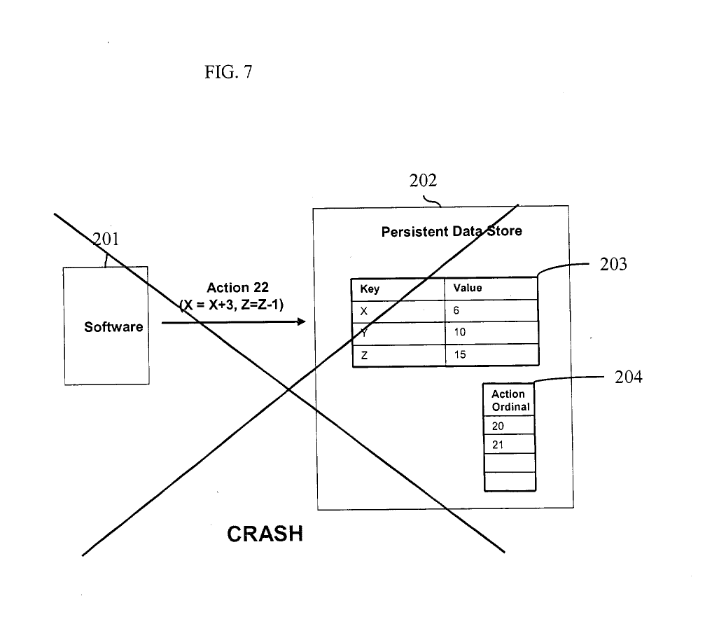

Referring now to FIG. 6, software 201 is shown sending another action with an indicia of “22” (“action ‘22’”) to data store 202. Specifically, action “22” sent by software 201 instructs data store 202 to add “3” to record X and to decrement record Z. Let assume that there was a system crash of the data store or software or the communication between them before action “22” was received by data store 202 or that data store 202 was not able to execute action “22”. In this case, as shown in FIG. 7, record X, record Z and Action Table 204 are not updated.

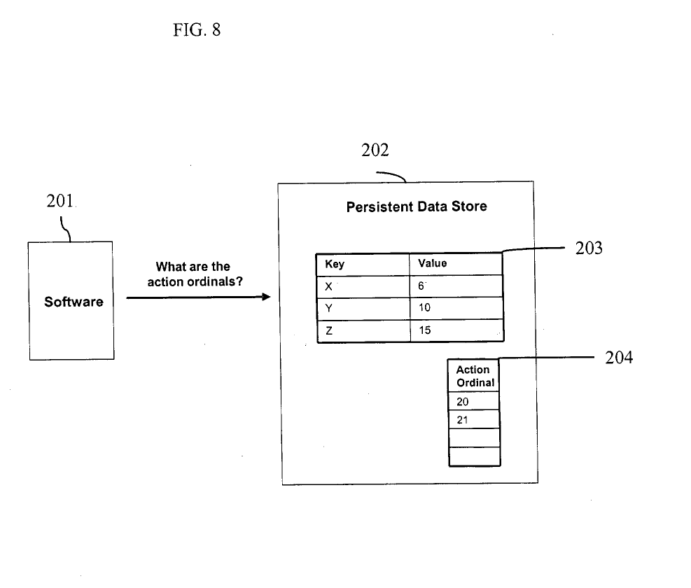

After recovery, software 201 does not know what actions were already reflected in data store 202 (for example, the crash could have occurred before action “22” was received by data store 202, or afterwards). Software 201 can query data store 202 to find out what were the action ordinals. This is depicted in FIG. 8.

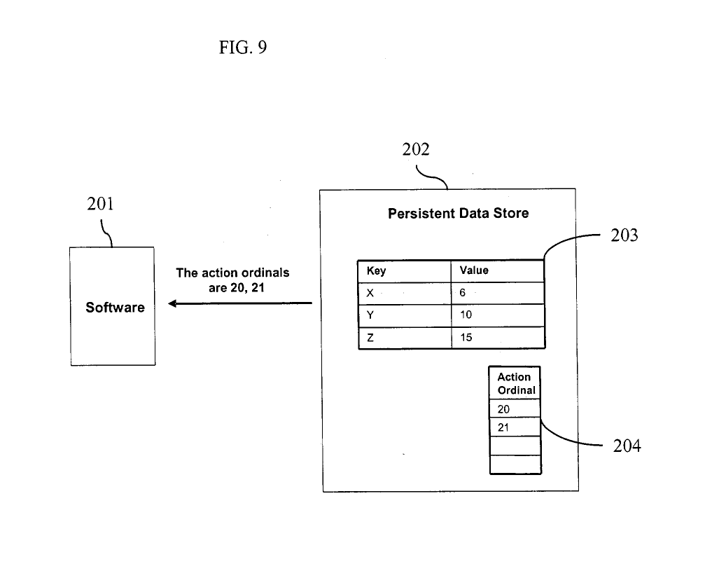

If data store 202 responses that it has only actions “20” and “21”, as shown in FIG. 9, software 201 is guaranteed (because of the data store atomicity), that action “22” is not reflected in data store 202, and therefore software 201 needs to resend action “22” to data store 202.

### 2. EXAMPLE 2

In an alternate embodiment, only the last completed action ordinal is retained. Thus, using the action ordinals described in Example 1 above, Action Table 204 only contains “21”. When system crashes before action “22” is received or executed by data store 202, no updates to the records of Action Table 204 take place. Upon recovery, software 201 queries data store 202 for the last action ordinal applied, which in this example is “21”, and thus software 201 knows that action “22” needs to be resent to data store 202.

Although these examples are illustrated using a sequential global persistent order, other orders may be used and would be apparent to one skilled in the art to make the necessary modifications.

The present invention may be implemented in hardware or software, or a combination of the two. Moreover, software as used herein refers to not only the computer programs, but to computer system that run such programs. Preferably, the present invention is implemented in one or more computer programs in communications with each other and executing on programmable computers which each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner. For illustrative purposes the present invention is embodied in the system configuration, method of operation and product or computer-readable medium, such as floppy disks, conventional hard disks, CD-ROMS, Flash ROMS, nonvolatile ROM, RAM and any other equivalent computer memory device. It will be appreciated that the system, method of operation and product may vary as to the details of its configuration and operation without departing from the basic concepts disclosed herein.

In the manner described above, the present invention thus provides a system and method to ensure updates to a data store. The scope of the present invention not limited, however, to data stores. Other areas where the software needs to guarantee exactly once semantics and wants to know what actions were reflected in the data store can also use the present invention. While this invention has been described with reference to the preferred embodiments, these are illustrative only and not limiting, having been presented by way of example. Other modifications will become apparent to those skilled in the art by study of the specification and drawings. It is thus intended that the following appended claims include such modifications as fall within the spirit and scope of the present invention.

What we claim is:

1. A system for guaranteeing exactly-once updates to data stores comprising:
a. a plurality of actions, each action having an indicia associated with said action;
b. a global persistent order defining the order by which said plurality of actions are to be applied to a data store;
c. software for transmitting said actions and said indicia to a data store.

2. A system according with claim 1 wherein the order of said global persistent order is a sequential order.

3. A system according with claim 1 wherein the order of said global persistent order is defined by an acyclical graph.

4. A system according with claim 1 wherein the system further includes software which retains in a non-volatile form the order of actions and associated indicia.

5. A method for guaranteeing exactly-once updates to data stores comprising:
a. defining a global persistent order defining the order by which said plurality of actions are to be applied to a data store;
b. generating an action;
c. generating an indicia associated with said action;
d. transmitting said action, along with said associated indicia, to a data store.

6. A method according to claim 5 wherein said steps are performed by software.

7. A method according to claim 6 comprising the additional steps of:
a. recording said indicia and associated action by said software.

8. A method according to claim 7 comprising the additional steps of:
a. receiving said action and said associated indicia by said data store;
b. recording said action indicia by said data store indicating completion of said action.

9. A method according to claim 7 comprising the additional steps of:
a. querying said data store for said indicia;
b. receiving from said data store said indicia;
c. analyzing said received indicia to determine said last action performed by said data store;
d. retransmitting said actions recorded by said software that were not performed after the last action reported by said data store in accordance with said indicia received from said data store.

10. A system for guaranteeing exactly-once updates to a data store comprising:
a. a data store;
b. software having predetermined indicia associated with an action, said software in communications with said data store;
c. receiving said action and associated indicia by said data store from said software;
d. recording said action indicia by said data store indicating completion of said action.
